(19) United States
(12) Patent Application Publication
(10) Pub. No.: US 2008/0129765 A1
(43) Pub. Date: Jun. 5, 2008

(54) Image adjustment method for display

(76) Inventors: Cheng-Feng Lin, Toufen Township (TW); Cheng-Lian Liu, Toufen Township (TW); Wen-Kai Teng, Toufen Township (TW); Jung-Hsiang Tseng, Hsinchu City (TW); Herng-Der Chu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/806,274

(22) Filed: May 31, 2007

(30) Foreign Application Priority Data
Dec. 4, 2006 (TW) 95145003

(51) Int. Cl. G09G 5/02

(52) U.S. Cl. 345/694

(57) ABSTRACT

An image adjustment method for displays is disclosed. Firstly, scan images on a display to get a coordinate of non-uniform brightness. Then the coordinate of non-uniform brightness is measured to obtain a chromatic value and a compensation value list is established according to a threshold value. Next brightness of images on the display is adjusted according to the coordinate of non-uniform brightness and the compensation value list so as to achieve uniform brightness of images, reduced labor cost and higher line speed.

### BACKGROUND OF THE INVENTION

The present invention relates to an image adjustment method, especially to an image adjustment method for displays.

Due to fast development of technology, various products are manufactured in order to meet people's requirements. In early days, most of monitors are CRT (Cathode Ray Tube). The CRT monitors have large volume, high power consumption and radiation. Thus they are replaced by liquid crystal displays (LCD) with features of light weight, compact design, low power and low radiation that have become mainstream in the market.

Generally, when the displays are out of the factory, they need to pass quality control processes so as to avoid defects such as non-uniform brightness of images generated during automated production processes. It's labor consuming to check and adjust brightness problems of the displays caused by different material of components of displays.

Moreover, due to manufacturing processes of the display panel, non-uniform brightness on images of the display panel of the same batch always appears on certain area of the display panel. While performing quality control process, it's not only labor consuming but also delay speed of production lines.

There is a need to invent a new image adjustment method for displays that improves non-uniform brightness on certain area of the image of the display.

### SUMMARY OF THE INVENTION

Therefore it is a primary object of the present invention to provide an image adjustment method for displays that adjusts the brightness of images on displays according to a scanned position list and a compensation value list so as to make brightness more uniform.

It is another object of the present invention to provide an image adjustment method for displays that adjusts the brightness of images on displays according to a scanned position list and a compensation value list so as reduce labor cost and increase production speed

An image adjustment method for displays according to the present invention includes a plurality of steps. At first, scan an image on the display to get a coordinate of non-uniform brightness. Then measure the coordinate of non-uniform brightness to obtain a chromatic value and set up a compensation value list according to a threshold value. Next images on the display are adjusted according to coordinate area of non-uniform brightness and the compensation value list.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart of an embodiment according to the present invention;

FIG. 2 is a block diagram of an embodiment according to the present invention.

### DETAILED DESCRIPTION OF THE PREFERRED EMBODIMENT

An image adjustment for displays according to the present invention is applied to liquid crystal displays. This is a preferred embodiment.

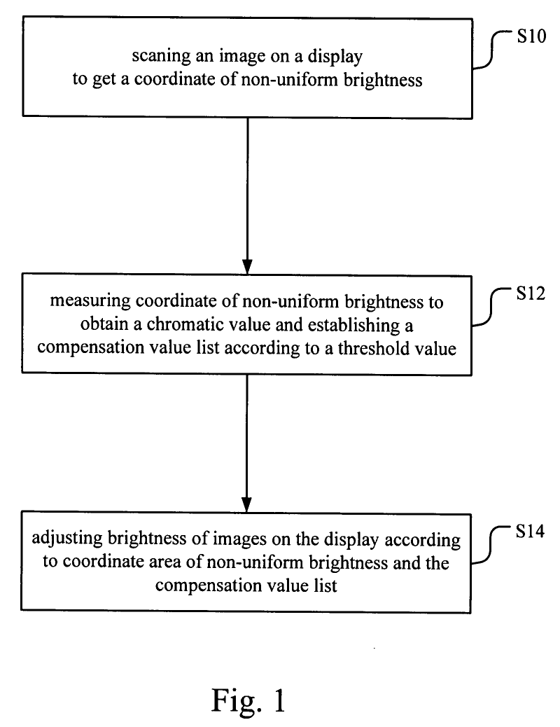

Refer to FIG. 1, firstly take step S10, scan an image on a display to get a coordinate of non-uniform brightness. That means scan images on displays while only a single color is displaying to get a coordinate or coordinate area of non-uniform brightness for establishing a position (coordinate) contrast list that is written into an application specific integrated circuit (ASIC). It is noted that a way to get the coordinate of non-uniform brightness of images on displays is to compare brightness of a first pixel with brightness of a second pixel for generating a comparison value in sequence while scanning images. When the comparison value is over a reference value, it is learned there is brightness variations between the two pixels. Positions of brightness of the first pixel as well as the second pixel are saved to set up a position list.

Or a charge couple device (CCD) is used to scan images on the display to get coordinate of non-uniform brightness. The two ways mentioned above to get positions of non-uniform brightness of images on the displays are only part of embodiments of scanning displays according to the present invention. Moreover, only one of each batch of displays needs to be scanned for obtaining a coordinate of non-uniform brightness because non-uniform brightness of the display panel of the same batch always appears on certain area of the display panel. Therefore, time-wasting and increased manufacturing cost caused by scanning of each display can be avoided.

Then take step S12, measure coordinate of non-uniform brightness to obtain a chromatic value and establish a compensation value list according to a threshold value. An optical measuring instrument is used to inspect coordinate of non-uniform brightness and coordinate of uniform brightness respectively so as to get a chromatic value and a threshold value respectively. The threshold value presents a chromatic value of a normal color. According to the threshold value, the chromatic value is reset so as to make the brightness of the display uniform and establish the compensation value list. That means color of non-uniform chromatic value is different from color of the threshold value. Thus the chromatic value needs to be reset so as to make color of non-uniform brightness the same with normal color and set up a compensation value list. According to a difference between the chromatic value and the threshold value, the compensation value list is established. Or the compensation value list is set up by adjusting the chromatic value to the threshold value. That means record an original chromatic value of the display as well as a redefined chromatic value and then also write the compensation value list into the ASIC. Next, run step S14, adjust brightness of images on the display according to coordinate area of non-uniform brightness and the compensation value list. This means write the position list and the compensation value list into the ASIC for controlling brightness of images on the display.

Furthermore, the ASIC controls driving chips of liquid crystal displays according to the position list and the compensation value list so as to adjust rotation angle of the liquid crystal for achieving uniform brightness, or by controlling illuminance of CCFL (Cold Cathode Fluorescent Lamp) or LED (light emitting diode), uniform brightness is achieved.

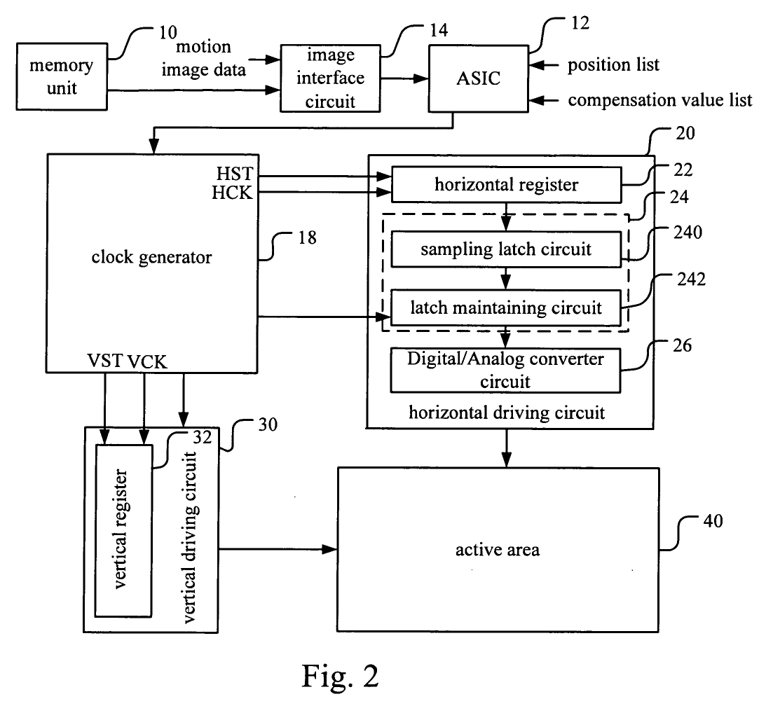

Refer to FIG. 2, the display consists of a memory unit, an application specific integrated circuit (ASIC) 12, an image interface circuit 14, a clock generator 18, a horizontal driving circuit 20, and a vertical driving circuit 30, all disposed on a glass substrate that is a display panel (not shown in figure). Both are coupled to an active area 40 of the display panel. The position list and compensation value list of the present invention are written into the ASIC 12 while the memory unit 10 is used to save static image files such as raw, bmp (bitmap) or jpg format. The memory unit 10 can be a Static random access memory (SRAM) or a flash memory.

The image interface circuit 14 is for receiving still image data or motion image data in the memory unit 10. For example, audio video data such as mpeg2 or mpeg4 is processed to generate image data that is in RGB or YUV format. After receiving the still or motion image data, the image interface circuit 14 sends data into the ASIC 12.

The ASIC 12 is for receiving the still image data or the motion image data transmitted from the image interface circuit 14 and then according to the position list and the compensation value list written into the ASIC 12, the still image data or the motion image data is corrected. That means positions of the still image or the motion image data to be adjusted are found according to the position list and then the found data is converted into data established in the compensation value list or is added with the compensation value. The ASIC 12 outputs normal image data and adjusted image data into the clock generator 18. Then by control of the clock pulse, the image data is output into the horizontal driving circuit 20, and the vertical driving circuit 30 in sequence.

The clock generator 18 receives control signal provided by the ASIC 12 so as to generate a vertical start signal VST, a vertical clock signal VCK, a horizontal start signal HST and a horizontal clock signal HCK.

The horizontal driving circuit 20 includes a horizontal register 22 that receives the horizontal start signal HST and the horizontal clock signal HCK and then delays the horizontal start signal HST according to the horizontal clock signal HCK so as to generate a sampling clock signal. The sampling clock signal is used to sample an image data transmitted from external devices. According to a control signal, the clock generator 18 generates a clock control signal that is sent to the horizontal driving circuit 20 for control of the horizontal driving circuit 20.

The horizontal driving circuit 20 consists of a latch module 24 and a Digital/Analog converter circuit 26. The latch module 24 includes a sampling latch circuit 240 and a latch maintaining circuit 242. According to the sampling clock signal generated by the horizontal register 22, the sampling latch circuit 240 samples image data to generate a plurality of sampling data. The image data is data transmitted from the ASIC 12. In accordance with the clock control signal, the latch maintaining circuit 242 keeps the sampling data of the sampling latch circuit 240. while the Digital/Analog converter circuit 26 converts these sampling data into analog signals and transmits them to data lines (not shown in figure) on the active area 40 of the display panel for showing images.

The vertical driving circuit 30 includes a vertical register 32 that that receives the vertical start signal VST and the vertical clock signal VCK and then delays the vertical start signal VST according to the vertical clock signal VCK so as to generate a selective clock signal. The selective clock signal is used to select and control vertical scanning lines (not shown in figure) on the active area 40.

In addition, according to the position list and the compensation value list, the ASIC 12 controls the horizontal driving circuit 20 and further regulates rotation angle of liquid crystals so as to adjust brightness for achieving uniform brightness of the display. Or by control of illuminance of CCFL (Cold Cathode Fluorescent Lamp) as well as LED (light emitting diode), uniform brightness is also achieved.

In summary, an image adjustment according to the present invention includes several steps. Scanning an image on a display gets a position list of non-uniform brightness. Then measure a chromatic value of the image and a compensation value list is established according to a threshold value. Next adjust brightness of the image on the display according to the coordinate of non-uniform brightness and the compensation value list.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An image adjustment method for displays for adjusting non-uniform brightness on certain area of a display panel comprising the steps of:
scanning the image on the display to get a coordinate of non-uniform brightness;
measuring the coordinate of the display to obtain a chromatic value and establishing a compensation value list according to a threshold value; and
adjusting brightness of the display according to the coordinate and the compensation value list.

2. The method as claimed is claim 1, wherein in the steps of measuring the coordinate of the display to obtain a chromatic value and establishing a compensation value list according to a threshold value, an optical measuring instrument is used to measure the coordinate of the display.

3. The method as claimed is claim 1, wherein the compensation value list is established according to a difference between the chromatic value and the threshold value.

4. The method as claimed is claim 1, wherein the chromatic value is able to be adjusted to the threshold value for establishing the compensation value list.

5. The method as claimed is claim 1, wherein before the step of scanning the image on the display to get a coordinate of non-uniform brightness, the method further comprising a step of:
showing the image on the display in a single color.

6. The method as claimed is claim 1, wherein the step of scanning the image on the display to get a coordinate of non-uniform brightness further comprising steps of:
comparing brightness of a first pixel with brightness of a second pixel for generating a comparison value; and
saving coordinates of brightness of the first pixel as well as the second pixel while the comparison value is over a reference value.

7. The method as claimed is claim 1, wherein a charge couple device (CCD) is used to scan the image on the display to get the coordinate.

8. The method as claimed is claim 1, wherein scanning the image on the display is to get the coordinate of non-uniform brightness and set up a position list.

9. The method as claimed is claim 1, wherein the method further comprising a step of:
measuring the coordinate of non-uniform brightness of the display to generate the threshold value.

10. The method as claimed is claim 1, wherein the threshold value is the chromatic value.

11. The method as claimed is claim 1, wherein the display is a liquid crystal display.

12. The method as claimed is claim 11, wherein brightness of the image of the liquid crystal display is adjusted by control of rotation angle of liquid crystal according to the coordinate of non-uniform brightness and the compensation value list.

13. The method as claimed is claim 1, wherein non-uniform brightness appears on certain area of each batch of the display panel.

14. The method as claimed is claim 11, wherein brightness of the image of the liquid crystal display is adjusted by control of a light source of the liquid crystal display according to the coordinate of non-uniform brightness and the compensation value list.

15. The method as claimed is claim 14, wherein the light source is a cold cathode fluorescent lamp (CCFL).

16. The method as claimed is claim 14, wherein the light source is a light emitted diode (LED).
